(19) United States
(12) Patent Application Publication
(10) Pub. No.: US 2026/0095638 A1
(43) Pub. Date: Apr. 2, 2026

(54) LENS MODULE AND ELECTRONIC DEVICE

(71) Applicant: Newmax Technology Co., Ltd., Taichung City (TW)

(72) Inventors: Yung-Fu LIANG, Taichung City (TW); Tsung-Kuei WANG, Taichung City (TW)

(21) Appl. No.: 19/017,400

(22) Filed: Jan. 10, 2025

(30) Foreign Application Priority Data
Sep. 30, 2024 (TW) 113137458

(51) Int. Cl. H04N 23/54; G02B 7/02; G03B 17/12; H04N 23/51; H04N 23/55

(52) U.S. Cl. CPC H04N 23/54; G02B 7/021; G03B 17/12; H04N 23/51; H04N 23/55

(57) ABSTRACT

A lens module includes: a circuit board including a window structure that penetrates from an upper surface to a lower surface; a lens barrel disposed on the upper surface of the circuit board; an optical lens assembly disposed in the lens barrel and corresponding to the window structure, wherein the optical lens assembly includes a first lens to an N-th lens, and the N-th lens is the lens of the optical lens assembly being the closest to an image side; and an optical sensor disposed and electrically connected to the lower surface of the circuit board and corresponding to the window structure of the circuit board; wherein one end portion of the lens barrel toward the image side is provided with an annular protrusion, and the annular protrusion surrounds a central axis, and the annular protrusion is closer to the image side than an image-side surface of the N-th lens.

This application claims the benefit of Taiwan Patent Application No. 113137458, filed on Sep. 30, 2024, which is hereby incorporated by reference for all purposes as if fully set forth herein.

### BACKGROUND

### Technical Field

The present disclosure relates to a lens module, and in particular to an electronic device having a lens module.

### Related Art

Currently, in the lens module industry, there are mainly packaging processes such as Chip Scale Package (CSP), Chip On Board (COB) and Flip Chip (FC).

Wafer-level packaging (CSP) usually uses wafer-level glass and wafer bonding and uses cofferdams to separate the image sensor chips on the wafer, and then fabricates them in the pad area of the polished wafer by using Silicon via technology (TSV: Through Silicon Via) for ring metal connection on the surface of the pad or on the side of the hole in the pad surface, or T-shaped metal contact on the side of the pad after cutting, wafer size packaging technology. And the extending circuit on the back of the wafer is fabricated with solder balls Ball Grid Array (BGA), then is cut to form an optical sensor unit of a single sealed cavity, and subsequently is formed into a modular structure by using Surface Mounting Technology (SMT). In chip-on-substrate packaging (COB), the backside of the grinded and cut chip is welded to the pad of the printed circuit board by using metal wires, and a bracket and lens with an infrared glass sheet are installed to form an assembled structure. Flip chip packaging (FC) connects pads (metal bumps) of the ground and cut chip and pads of the printed circuit board (PCB) at one time through the action of thermal ultrasound to form a package structure. Subsequently, the pads or solder balls on the outside of the printed circuit board uses the surface mounting technology to form a module structure.

FIG. 1 is a schematic cross-sectional view of a lens module in the prior art, which shows that the optical sensor is packaged in a chip-on-substrate (COB) packaging process. Please refer to FIG. 1, the lens module 9 includes a lens barrel 91, an optical lens assembly 92 and an optical sensor 93. The lens barrel 91 is disposed on a circuit board 90, the optical lens assembly 92 is disposed in the lens barrel 91, and the optical sensor 93 is disposed and electrically connected to the circuit board 90. However, the height of the above-mentioned lens module 9 cannot meet the requirement of low module height. Among other packaging processes, flip-chip (FC) packaging process can achieve lower module height and better signal transmission quality.

Thus, a lens module needs to be provided for meeting previous requirements.

### SUMMARY

An objective of the present disclosure is to provide a lens module including an annular protrusion that can prevent an image-side surface of the N-th lens from being easily scratched or damaged by foreign objects

To achieve the above objective, the present disclosure provides a lens module, defining a central axis, an object side, and an image side opposite to the object side, the lens module comprising: a circuit board having an upper surface to a lower surface opposite to each other, and comprising a window structure that penetrates from the upper surface to the lower surface; a lens barrel disposed on the upper surface of the circuit board; an optical lens assembly disposed in the lens barrel and corresponding to the window structure, wherein the optical lens assembly includes a first lens to an N-th lens, the N-th lens is the lens of the optical lens assembly being the closest to an image side, N is an integer greater than zero, and the N-th lens includes an image-side surface; and an optical sensor disposed and electrically connected to the lower surface of the circuit board, and corresponding to the window structure of the circuit board; wherein one end portion of the lens barrel toward the image side is provided with an annular protrusion, and the annular protrusion surrounds the central axis, and the annular protrusion is closer to the image side than the image-side surface of the N-th lens.

The present disclosure further provides an electronic device, comprising: a housing; the above-mentioned lens module disposed in the housing, and a control component disposed in the housing and electrically connected to the optical sensor.

The height of the lens module of the present disclosure can be reduced. Especially when used with a flip chip type sensor, the overall height of the lens module can be reduced by about 0.15 to 0.20 mm, and the screen thickness of the electronic device can be reduced. According to the lens module of the present disclosure, the annular protrusion can prevent the image-side surface of the N-th lens from being easily scratched or damaged by foreign objects. Furthermore, the annular protrusion can extend into the window structure, thereby improving the positioning capacity of the lens module to the circuit board.

### BRIEF DESCRIPTION OF THE DRAWINGS

FIG. 1 is a schematic cross-sectional view of a lens module in the prior art.

FIG. 2 is a schematic sectional view of a lens module according to the first embodiment of the present disclosure.

FIG. 3 is a schematic sectional view of a lens barrel and an optical lens assembly of the lens module according to the first embodiment of the present disclosure.

FIG. 4 is a schematic perspective view of a lens barrel and an optical lens assembly of a lens module according to an embodiment of the present disclosure.

FIG. 5 is a schematic side view of a lens barrel and an optical lens assembly of a lens module according to an embodiment of the present disclosure.

FIG. 6 is a schematic perspective view of a lens barrel and an optical lens assembly of a lens module according to another embodiment of the present disclosure.

FIG. 7 is a schematic side view of a lens barrel and an optical lens assembly of a lens module according to another embodiment of the present disclosure.

FIG. 8a is a schematic bottom view of a lens barrel and an optical lens assembly of a lens module according to a further embodiment of the present disclosure.

FIG. 8b is a schematic bottom view of a lens barrel and an optical lens assembly of a lens module according to other embodiment of the present disclosure.

FIG. 9 is a schematic sectional view of a lens barrel and an optical lens assembly of a lens module according to the second embodiment of the present disclosure.

FIG. 10 is a schematic plan view of a circular flat sheet of an optical lens assembly of a lens module according to the second embodiment of the present disclosure.

FIG. 11 is a schematic sectional view of a lens barrel and an optical lens assembly of a lens module according to the third embodiment of the present disclosure.

FIG. 12 is a schematic sectional view of an electronic device according to an embodiment of the present disclosure.

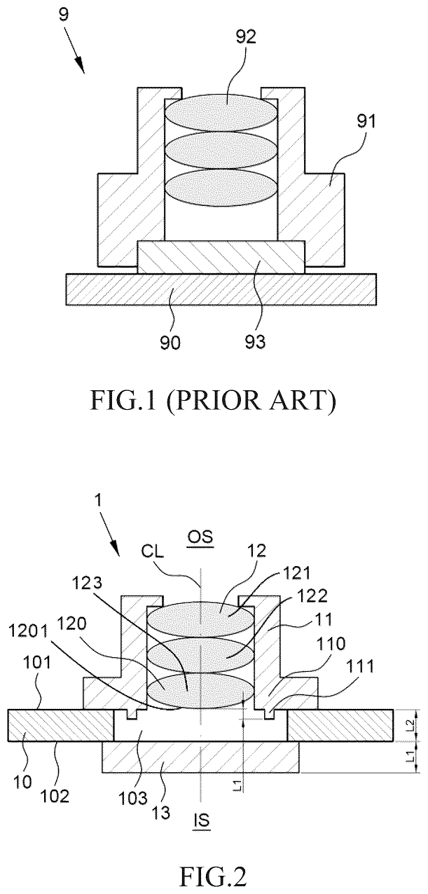

### DETAILED DESCRIPTION

To make the foregoing objectives, characteristics and features of the present disclosure more comprehensible, preferred embodiments of the present disclosure are described in detail below with reference to the accompanying drawings.

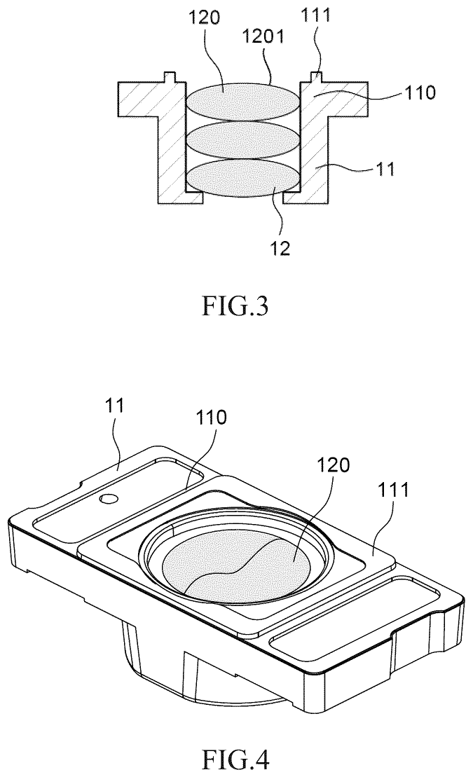

FIG. 2 is a schematic sectional view of a lens module according to the first embodiment of the present disclosure. FIG. 3 is a schematic sectional view of a lens barrel and an optical lens assembly of the lens module according to the first embodiment of the present disclosure. Referring to FIG. 2 and FIG. 3, the lens module 1 defines a central axis CL, an object side OS and an image side IS opposite to the object side OS, and includes: a circuit board 10, a lens barrel 11, an optical lens assembly 12 and an optical sensor 13. The circuit board 10 has an upper surface 101 and a lower surface 102 opposite to each other, and includes a window structure 103 that penetrates from the upper surface 101 to the lower surface 102. The thickness L2 of the circuit board 10 may be approximately 0.3 mm. The lens barrel 11 is disposed on the upper surface 101 of the circuit board 10.

The optical lens assembly 12 is disposed in the lens barrel 11 and corresponds to the window structure 103. The optical lens assembly 12 includes, in order from an object side OS to an image side IS: the first lens to the N-th lens 120. The N-th lens 120 is the lens of the optical lens assembly 12 being the closest to an image side, N is an integer greater than zero, and the N-th lens 120 includes an image-side surface 1201. For example, the optical lens assembly 12 includes, in order from an object side OS to an image side IS: the first lens 121 to the third lens 123. The third lens 123 (i.e., the N-th lens 120) is the lens of the optical lens assembly 12 being the closest to an image side. The lens module 1 further includes a plurality of optical elements arranged in the lens barrel 11, and the optical elements can be a spacer ring, an optical filter (for example, an infrared optical filter, an infrared bandpass optical filter, or other optical band filters), a light-shielding element (for example, an aperture stop or a stop configured to correct edge light), or the like.

The optical sensor 13 is disposed and electrically connected to the lower surface 102 of the circuit board 10 and is corresponding to the window structure 13 of the circuit board 10. The optical sensor 13 can be an image sensor, and its thickness L3 may be approximately 0.3 mm.

The height of the lens module of the present disclosure can be reduced. Especially when used with a flip chip type sensor, the overall height of the lens module can be reduced by about 0.15 to 0.20 mm, and the screen thickness of the electronic device can be reduced.

Referring to FIG. 2 again, one end portion 110 of the lens barrel 11 toward the image side IS is provided with an annular protrusion 111. The annular protrusion 111 surrounds the central axis CL, and the annular protrusion 111 is closer to the image side IS than the image-side surface 1201 of the N-th lens 120, thereby preventing the image-side surface 1201 of the N-th lens 120 from being easily scratched or damaged by foreign objects. The distance L1 between the position of the annular protrusion 111 that is the closest to the image side IS and the image side surface 1201 of the N-th lens 120 may range from 0.01 to 0.6 mm. When the image-side surface 1201 of the N-th lens 120 does not extend into the window structure 103, and the thickness of the annular protrusion 111 can be between 0.01 and 0.6 mm. Furthermore, the annular protrusion 111 can extend into the window structure 103, thereby improving the positioning capability of the lens module 1 to the circuit board 10.

FIG. 4 is a schematic perspective view of a lens barrel and an optical lens assembly of a lens module according to an embodiment of the present disclosure. FIG. 5 is a schematic side view of a lens barrel and an optical lens assembly of a lens module according to an embodiment of the present disclosure. Referring to FIG. 2, FIG. 4 and FIG. 5, the annular protrusion 111 is a rectangular annular protrusion surrounding the central axis CL. The rectangular annular protrusion is easy to manufacture and can prevent the image-side surface 1201 of the N-th lens 120 from being easily scratched or damaged by foreign objects.

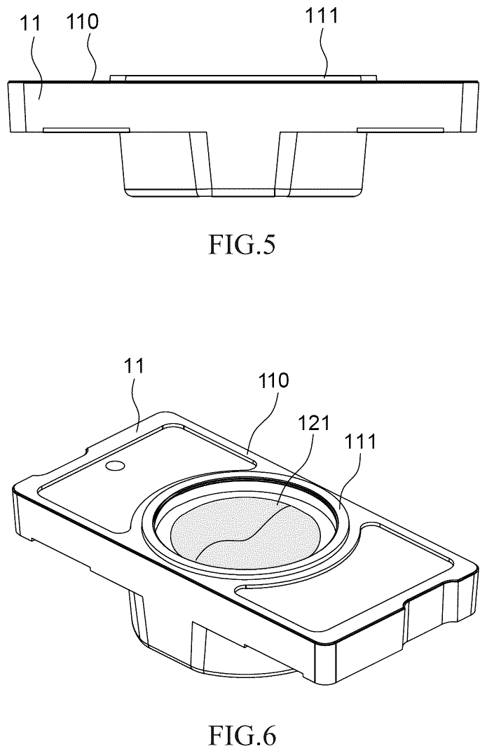

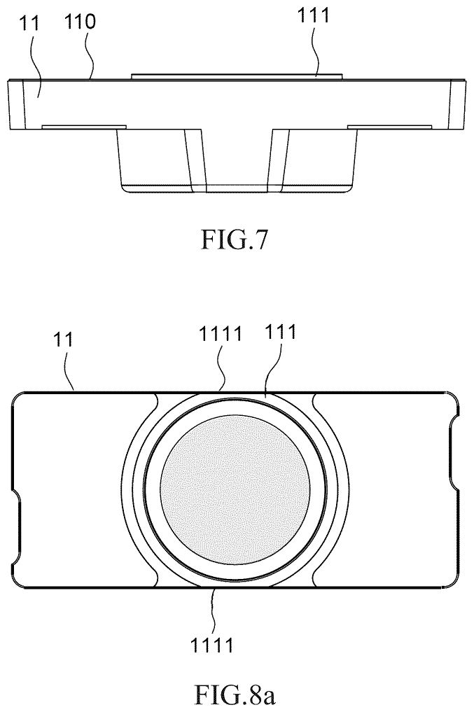

FIG. 6 is a schematic perspective view of a lens barrel and an optical lens assembly of a lens module according to another embodiment of the present disclosure. FIG. 7 is a schematic side view of a lens barrel and an optical lens assembly of a lens module according to another embodiment of the present disclosure. Referring to FIG. 2, FIG. 6 and FIG. 7, the annular protrusion 111 is a circular annular protrusion surrounding the central axis CL. The circular annular protrusion is easy to manufacture and can prevent the image-side surface 1201 of the N-th lens 120 from being easily scratched or damaged by foreign objects.

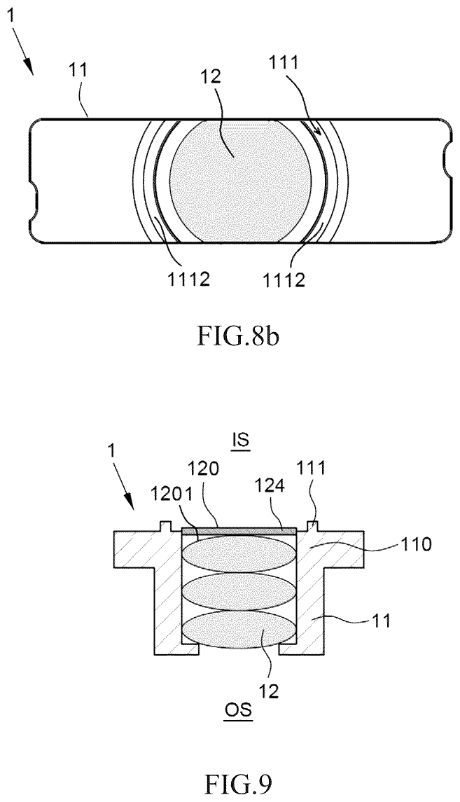

FIG. 8a is a schematic bottom view of a lens barrel and an optical lens assembly of a lens module according to a further embodiment of the present disclosure. Referring to FIG. 2 and FIG. 8a, the annular protrusion 111 includes two cut edges 1111, and the two cut edges are planar. The lens module 1 is reduced to the lens barrel 11 along a special direction, whereby the lens module 1 can be used in narrow-frame electronic devices (such as narrow-frame mobile phones). FIG. 8b is a schematic bottom view of a lens barrel and an optical lens assembly of a lens module according to other embodiment of the present disclosure. Referring to FIG. 2 and FIG. 8b, the annular protrusion 111 includes first and second arc-shaped portions 1112, 1113. The first and second arc-shaped portions 1112, 1113 are symmetrically arranged. The lens module 1 is reduced to the lens barrel 11 and the optical lens assembly 12 along a special direction, whereby the lens module 1 can be used in ultra narrow-frame electronic devices (such as ultra narrow-frame mobile phones).

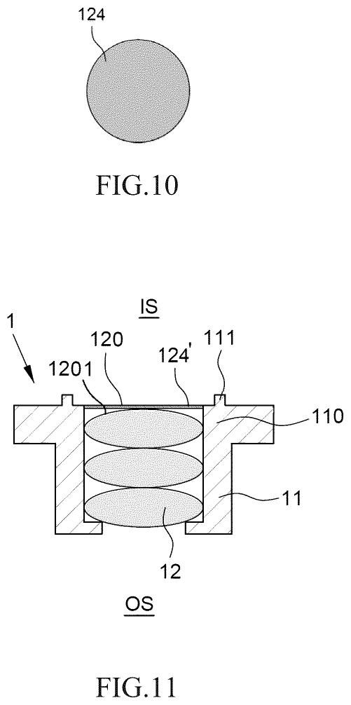

FIG. 9 is a schematic sectional view of a lens barrel and an optical lens assembly of a lens module according to the second embodiment of the present disclosure. FIG. 10 is a schematic plan view of a circular flat sheet of an optical lens assembly of a lens module according to the second embodiment of the present disclosure. Referring to FIG. 2, FIG. 9 and FIG. 10, the optical lens assembly 12 further includes a circular flat sheet 124 (such as an optical filter, etc.). The outer diameter of the circular flat sheet 124 is the same as the outer diameter of the N-th lens 120. The circular flat sheet 120 is disposed in a non-optical region of the image-side surface 1201 of the N-th lens 120, and the annular protrusion 111 is closer to the image side IS than the circular flat sheet 120, thereby preventing the image-side surface 1201 of the N-th lens 120 from being easily scratched or damaged by foreign objects.

FIG. 11 is a schematic sectional view of a lens barrel and an optical lens assembly of a lens module according to the third embodiment of the present disclosure. Referring to FIG. 2 and FIG. 11, the optical lens assembly 12 further includes a circular flat sheet 124′ (such as an optical filter, etc.). The outer diameter of the circular flat sheet 124′ is the same as the outer diameter of the N-th lens 120. The circular flat sheet 124′ is disposed in a non-optical region of the image side surface 1201 of the N-th lens 120. The circular flat sheet 124′ is aligned with the end portion 110 of the lens barrel 11, and the annular protrusion 111 is closer to the image side IS than the end portion 110, thereby preventing the image-side surface 1201 of the Nth lens 120 from being easily scratched or damaged by foreign objects.

According to the lens module of the present disclosure, the annular protrusion can prevent the image-side surface of the N-th lens from being easily scratched or damaged by foreign objects. Furthermore, the annular protrusion can extend into the window structure, thereby improving the positioning capacity of the lens module to the circuit board.

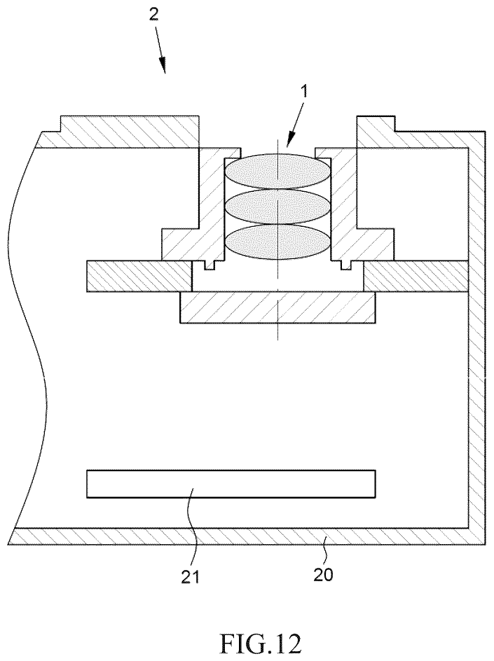

FIG. 12 is a schematic sectional view of an electronic device according to an embodiment of the present disclosure. The electronic device 2 includes: a housing 20, the lens module 1 of the present disclosure, and a control component 21. The lens module 1 is disposed in the housing 20. The control component 21 is disposed in the housing 20 and is electrically connected to the optical sensor of the lens module 1. The electronic device 2 of the present disclosure can be a mobile phone, a laptop, etc. In addition, the lens module provided by the present disclosure may be used in electronic imaging systems in photography, surveillance, automation equipment, vehicle surround systems, and electronic imaging systems in the internet of things (IOT) equipment, but is not limited thereto.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. A lens module, defining a central axis, an object side, and an image side opposite to the object side, the lens module comprising:
a circuit board having an upper surface to a lower surface opposite to each other, and comprising a window structure that penetrates from the upper surface to the lower surface;
a lens barrel disposed on the upper surface of the circuit board;
an optical lens assembly disposed in the lens barrel and corresponding to the window structure, wherein the optical lens assembly includes a first lens to an N-th lens, the N-th lens is the lens of the optical lens assembly being the closest to an image side, N is an integer greater than zero, and the N-th lens includes an image-side surface; and
an optical sensor disposed and electrically connected to the lower surface of the circuit board, and corresponding to the window structure of the circuit board;
wherein one end portion of the lens barrel toward the image side is provided with an annular protrusion, the annular protrusion surrounds the central axis, and the annular protrusion is closer to the image side than the image-side surface of the N-th lens.

2. The lens module according to claim 1, wherein a distance between the position of the annular protrusion that is the closest to the image side and the image side surface of the N-th lens is between 0.01 and 0.6 mm.

3. The lens module according to claim 1, wherein when the image-side surface of the N-th lens does not extend into the window structure, and a thickness of the annular protrusion is between 0.01 and 0.6 mm.

4. The lens module according to claim 1, wherein the annular protrusion extends into the window structure.

5. The lens module according to claim 1, wherein the annular protrusion is a rectangular annular protrusion surrounding the central axis or a circular annular protrusion surrounding the central axis.

6. The lens module according to claim 1, wherein the annular protrusion includes first and second arc-shaped portions, and the first and second arc-shaped portions are symmetrically arranged.

7. The lens module according to claim 1, wherein the annular protrusion includes two cut edges, and the two cut edges are planar.

8. The lens module according to claim 1, wherein the optical lens assembly further includes a circular flat sheet disposed on the image-side surface of the N-th lens, and the annular protrusion is closer to the image side than the circular flat sheet.

9. The lens module according to claim 1, wherein the optical lens assembly further includes a circular flat sheet disposed on the image-side surface of the N-th lens, the circular flat sheet is aligned with the end portion of the lens barrel, and the annular protrusion is closer to the image side than the end portion.

10. An electronic device, comprising:
a housing;
a lens module disposed in the housing, wherein:
the lens module defines a central axis, an object side, and an image side opposite to the object side, and the lens module comprises:
a circuit board having an upper surface to a lower surface opposite to the upper surface, and comprising a window structure that penetrates from the upper surface to the lower surface;
a lens barrel disposed on the upper surface of the circuit board;
an optical lens assembly disposed in the lens barrel and corresponding to the window structure, wherein the optical lens assembly includes a first lens to an N-th lens, the N-th lens is the lens of the optical lens assembly being the closest to an image side, N is an integer greater than zero, and the N-th lens includes an image-side surface; and
an optical sensor disposed and electrically connected to the lower surface of the circuit board, and corresponding to the window structure of the circuit board;
wherein one end portion of the lens barrel toward the image side is provided with an annular protrusion, and the annular protrusion surrounds the central axis, and the annular protrusion is closer to the image side than the image-side surface of the N-th lens; and
a control component disposed in the housing and electrically connected to the optical sensor.

11. The electronic device according to claim 10, wherein a distance between the position of the annular protrusion that is the closest to the image side and the image side surface of the N-th lens is between 0.01 and 0.6 mm.

12. The electronic device according to claim 10, wherein when the image-side surface of the N-th lens does not extend into the window structure, and a thickness of the annular protrusion is between 0.01 and 0.6 mm.

13. The electronic device according to claim 10, wherein the annular protrusion extends into the window structure.

14. The electronic device according to claim 10, wherein the annular protrusion is a rectangular annular protrusion surrounding the central axis or a circular annular protrusion surrounding the central axis.

15. The electronic device according to claim 10, wherein the annular protrusion includes first and second arc-shaped portions, and the first and second arc-shaped portions are symmetrically arranged.

16. The electronic device according to claim 10, wherein the annular protrusion includes two cut edges, and the two cut edges are planar.

17. The electronic device according to claim 10, wherein the optical lens assembly further includes a circular flat sheet disposed on the image-side surface of the N-th lens, and the annular protrusion is closer to the image side than the circular flat sheet.

18. The electronic device according to claim 10, wherein the optical lens assembly further includes a circular flat sheet disposed on the image-side surface of the N-th lens, the circular flat sheet is aligned with the end portion of the lens barrel, and the annular protrusion is closer to the image side than the end portion.
